(19) United States
(12) Patent Application Publication
(10) Pub. No.: US 2026/0295806 A1
(43) Pub. Date: Oct. 1, 2026

(54) STACKABLE ROLLING TOOLBOX

(71) Applicant: Nickolas Brands, LLC, Sarasota, FL (US)

(72) Inventors: Nickolas Reinhart, Sarasota, FL (US); Joe Klein, Findlay, OH (US); Ben Sayalith, Findlay, OH (US)

(21) Appl. No.: 19/566,173

(22) Filed: Mar. 13, 2026

Related U.S. Application Data
(60) Provisional application No. 63/771,745, filed on Mar. 14, 2025.

(51) Int. Cl. B25H 3/02; B65D 21/02

(52) U.S. Cl. CPC B25H 3/026; B65D 21/0223

(57) ABSTRACT

A toolbox can include a base having a bottom surface and sidewalls extending from the base. A plurality of first ribs can extend across the base and onto opposing sidewalls to provide structural support. Feet can be disposed on the first ribs and can extend from the bottom surface. A lid can be coupled to the sidewalls and can include a top surface with second ribs positioned to align with the first ribs. Recesses can be disposed on the second ribs and can receive corresponding feet of another toolbox when stacked. Wheels can be rotatably coupled to the base to enable mobility. The alignment of ribs between the base and lid can facilitate efficient load transfer when toolboxes are stacked. The feet-and-recess engagement can militate against lateral movement and can provide stable stacking. The toolbox can maximize vertical storage space while maintaining stability and structural integrity during transport.

### CROSS-REFERENCE TO RELATED APPLICATIONS

This application claims the benefit of U.S. Provisional Application No. 63/771,745, filed on Mar. 14, 2025. The entire disclosure of the above application is incorporated herein by reference.

### FIELD

The present technology relates to a toolbox, and, more particularly, to a stackable rolling toolbox for organizing and transporting tools and equipment.

### INTRODUCTION

This section provides background information related to the present disclosure which is not necessarily prior art.

A toolbox can be used in various settings such as workshops, garages, and job sites to organize and store tools and equipment. The design of a toolbox can significantly affect how efficiently space can be utilized and how easily tools can be accessed. In environments where multiple types of tools need to be stored, the ability to organize storage solutions effectively can be important for maintaining an orderly workspace. A toolbox can occupy considerable floor space, which may limit its practicality in smaller or more confined areas.

Mobility can be a factor in the usability of a toolbox, particularly when heavy tools need to be transported from one location to another. A toolbox without wheels may require lifting and carrying, which can be physically demanding and time-consuming. In cluttered or confined spaces, maneuvering a stationary toolbox can be cumbersome. The lack of a mobility feature may reduce the flexibility with which tools can be relocated to different work areas.

Vertical storage can help maximize the use of available space in workshops and garages. A toolbox may not include features that allow it to be securely stacked on top of another toolbox. Without a stacking mechanism, multiple toolboxes may need to be placed side by side, which can increase the horizontal footprint of the storage area. This arrangement can lead to inefficient use of space and may contribute to a disorganized work environment.

Stability during stacking can be a concern when a toolbox is placed on top of another toolbox. If the surfaces of stacked toolboxes do not engage properly, the upper toolbox may shift or become dislodged during handling or transport. This lack of secure engagement can pose safety risks and may result in damage to the toolbox or its contents. Features that militate against lateral movement between stacked units can be beneficial for maintaining stability.

The structural integrity of a toolbox can affect its durability and load-bearing capacity. A toolbox that lacks adequate reinforcement may experience deformation or failure when subjected to heavy loads or repeated use. Ribs and other structural elements can be incorporated into the design to enhance strength and rigidity. However, the placement and configuration of such reinforcements may vary, and not all designs may provide sufficient support for both the base and the lid.

Accordingly, there is a continuing need for a toolbox that can be easily transported and efficiently stacked to maximize vertical storage space. Desirably, such a toolbox would include features that allow for secure engagement between stacked units, militate against lateral movement, and provide adequate structural support to withstand loads during use and transport. Additionally, it would be beneficial for the toolbox to incorporate aligned reinforcing elements that facilitate load transfer between stacked units and enhance overall stability.

### SUMMARY

In concordance with the instant disclosure, a stackable and rollable toolbox with aligned structural ribs and interlocking features, has surprisingly been discovered. The present technology includes articles of manufacture, systems, and processes that relate to a stackable and rollable toolbox having structural ribs, feet, and recesses for secure stacking and efficient storage.

In certain embodiments, a toolbox is provided. The toolbox can include a base having a bottom surface and sidewalls extending from the base, the sidewalls including a first sidewall opposite a second sidewall. First ribs can extend across the base onto the first sidewall and onto the second sidewall to provide structural support. Feet can be disposed on the first ribs and can extend from the bottom surface. A lid can be coupled to the sidewalls and can include a top surface with second ribs positioned to align with the first ribs. Recesses can be disposed on the second ribs, each recess can be positioned to receive a corresponding foot of another toolbox when stacked thereon.

In certain embodiments, a toolbox system is provided. The toolbox system toolbox system can include a first toolbox and a second toolbox, each toolbox can include a base having a bottom surface and sidewalls extending from the base, the sidewalls including a first sidewall opposite a second sidewall. First ribs can extend across the base onto the first sidewall and onto the second sidewall to provide structural support. Feet can be disposed on the first ribs and can extend from the bottom surface. A lid can be coupled to the sidewalls and can include a top surface with second ribs positioned to align with the first ribs. Recesses can be disposed on the second ribs, each recess can be positioned to receive a corresponding foot of another toolbox when stacked thereon. Wheels can be rotatably coupled to each toolbox. The second toolbox can be stacked on top of the first toolbox with the feet of the second toolbox disposed in the recesses of the first toolbox.

In certain embodiments, a method of stacking a first toolbox and a second toolbox is provided. The method can include providing the first toolbox and the second toolbox, each toolbox can include a base having a bottom surface and sidewalls extending from the base, the sidewalls including a first sidewall opposite a second sidewall. First ribs can extend across the base onto the first sidewall and onto the second sidewall to provide structural support. Feet can be disposed on the first ribs and can extend from the bottom surface. A lid can be coupled to the sidewalls and can include a top surface with second ribs positioned to align with the first ribs.

Recesses can be disposed on the second ribs, each recess can be positioned to receive a corresponding foot of another toolbox when stacked thereon. Wheels can be rotatably coupled to each toolbox. The second toolbox can be stacked on top of the first toolbox with the feet of the second toolbox disposed in the recesses of the first toolbox. The method can include disposing the second toolbox on the first toolbox such that the feet of the second toolbox can be received in the recesses of the first toolbox, whereby the first toolbox and the second toolbox are placed in a stacked configuration.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a toolbox, according to an embodiment of the present disclosure;

FIG. 2 is a bottom perspective view of the toolbox, according to the embodiment shown in FIG. 1;

FIG. 3 is a front elevational view of the toolbox, according to the embodiment shown in FIG. 1;

FIG. 4 is a rear elevational view of the toolbox, according to the embodiment shown in FIG. 1;

FIG. 5 is a right-side elevational view of the toolbox, according to the embodiment shown in FIG. 1;

FIG. 6 is a left-side elevation view of the toolbox, according to the embodiment shown in FIG. 1;

FIG. 7 is a top plan view of the toolbox, according to the embodiment shown in FIG. 1;

FIG. 8 is a bottom plan view of the toolbox, according to the embodiment shown in FIG. 1;

FIG. 9 is a front elevational view of the toolbox with a second toolbox stacked thereon, according to an embodiment of the present disclosure;

FIG. 10 is an enlarged view of the portion of FIG. 9 indicated by callout 10 showing the toolbox with the second toolbox stacked thereon, according to the embodiment shown in FIG. 9;

FIG. 11 is a front elevational, cross-sectional view taken along a longitudinal centerline of the toolbox with the second toolbox stacked thereon, according to the embodiment shown in FIG. 9;

FIG. 12 is an enlarged view of the portion of FIG. 11 indicated by callout 12 showing the toolbox with the second toolbox stacked thereon, according to the embodiment shown in FIG. 9;

FIG. 13 is a right-side elevational, cross-sectional view taken at line 13-13 of FIG. 9 showing the toolbox with the second toolbox stacked thereon, according to the embodiment shown in FIG. 9;

FIG. 14 is an enlarged view of the portion of FIG. 13 indicated by callout 14 showing the toolbox with the second toolbox stacked thereon, according to the embodiment shown in FIG. 9;

FIG. 15 is a top perspective view of a toolbox, according to an embodiment of the present disclosure;

FIG. 16 is a front elevation view of the toolbox with a second toolbox stacked thereon, according to the embodiment shown in FIG. 15; and

FIG. 17 is a flowchart illustrating a method of stacking a first toolbox and a second toolbox thereon, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom.

Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to a toolbox that can be both rolled and stacked. The toolbox can include a base with ribs that can run across the bottom and up the sides of the toolbox, providing structural strength and rigidity. Feet can extend downward from these ribs, allowing the toolbox to sit stably on a flat surface and on another toolbox when stacked thereon. Wheels can be coupled to one end of the toolbox, and a handle can be located at the opposite end, allowing the user to tilt and roll the toolbox like a suitcase.

The lid of the toolbox can include ribs that can align with the ribs on the base, which can help distribute weight evenly when toolboxes are stacked. The lid can also include recesses that can be shaped and positioned to receive the feet of another toolbox placed on top. This interlocking system can militate against the upper toolbox from sliding or shifting when stacked, providing a secure and stable stacking arrangement.

The toolbox can be stacked with another toolbox, with the feet of the upper toolbox fitting into the recesses of the lower toolbox. The recesses can be designed so that a second toolbox can be placed in two orientations, rotated one hundred eighty degrees, and still fit securely on top of the lower toolbox. This flexibility, combined with the rolling and stacking features, can make the toolbox a practical and versatile storage solution for workshops, job sites, and garages.

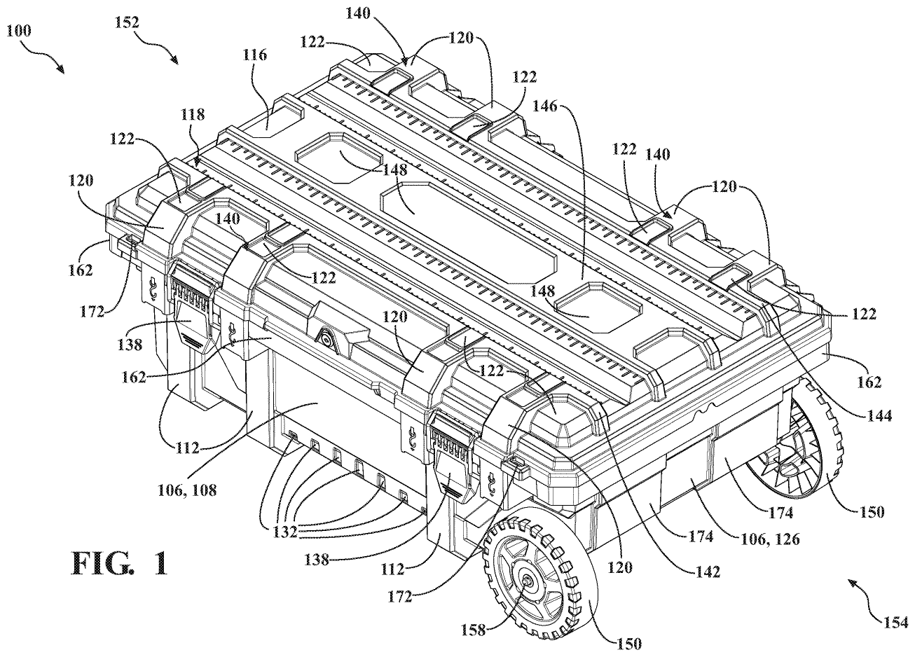

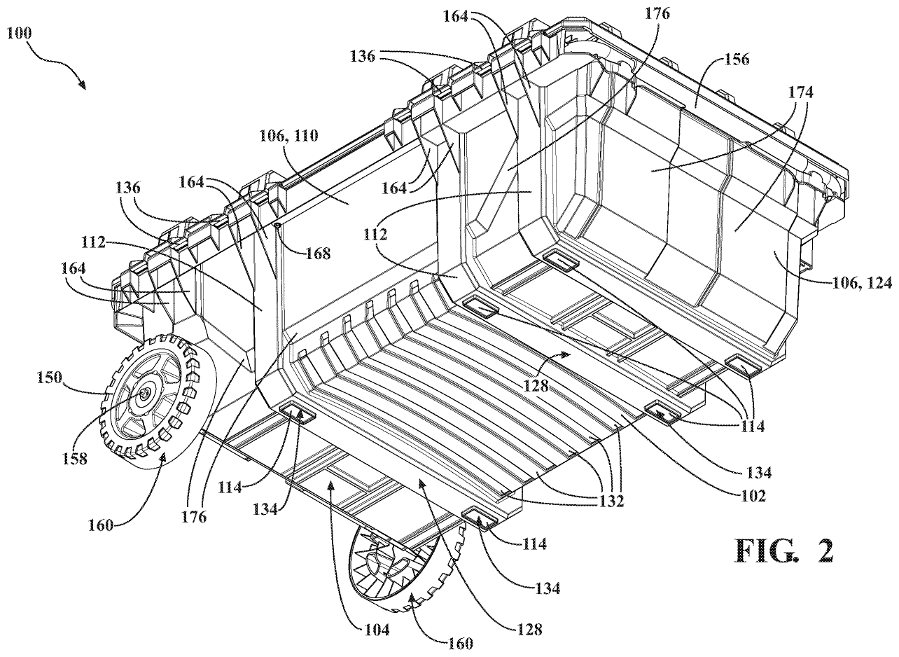

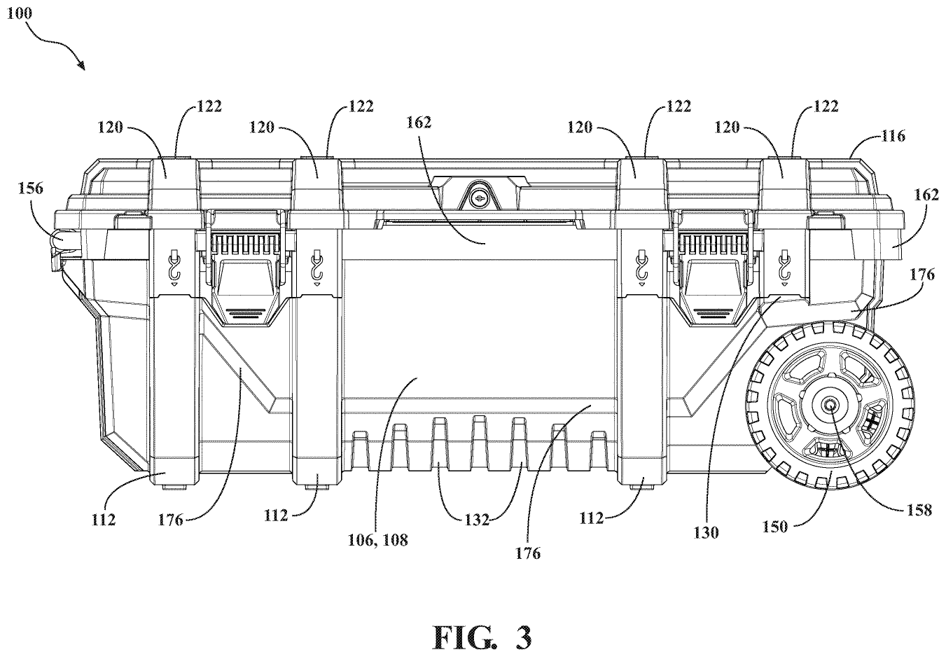

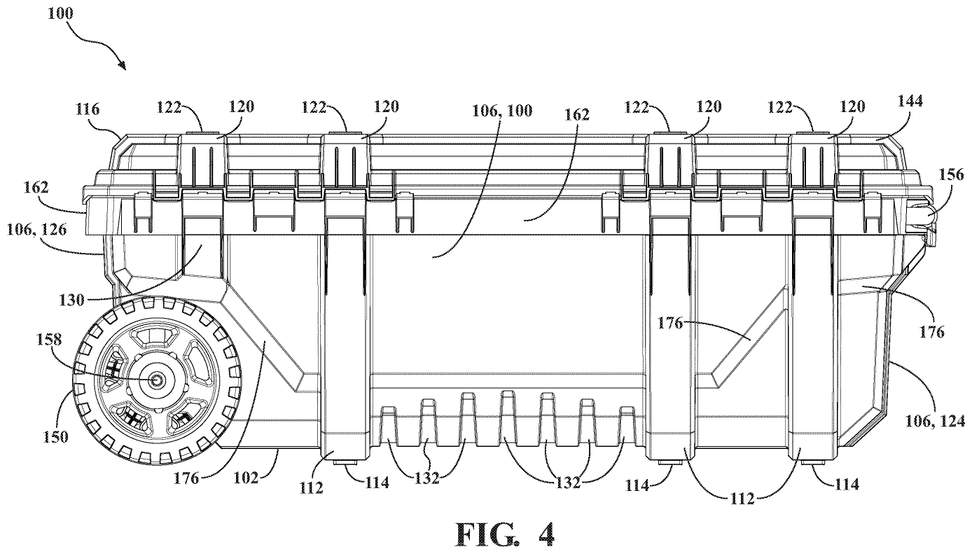

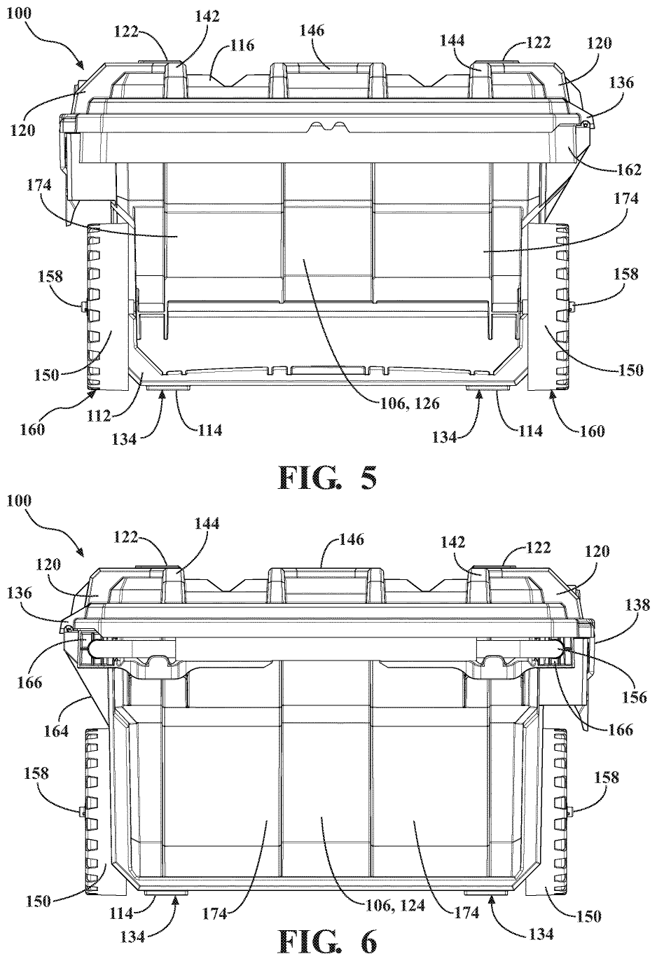

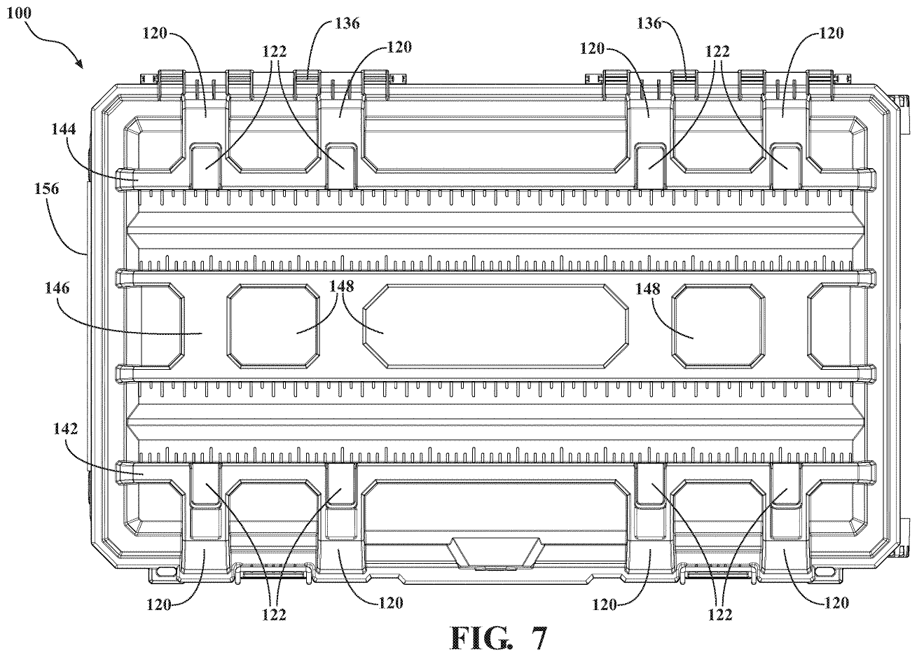

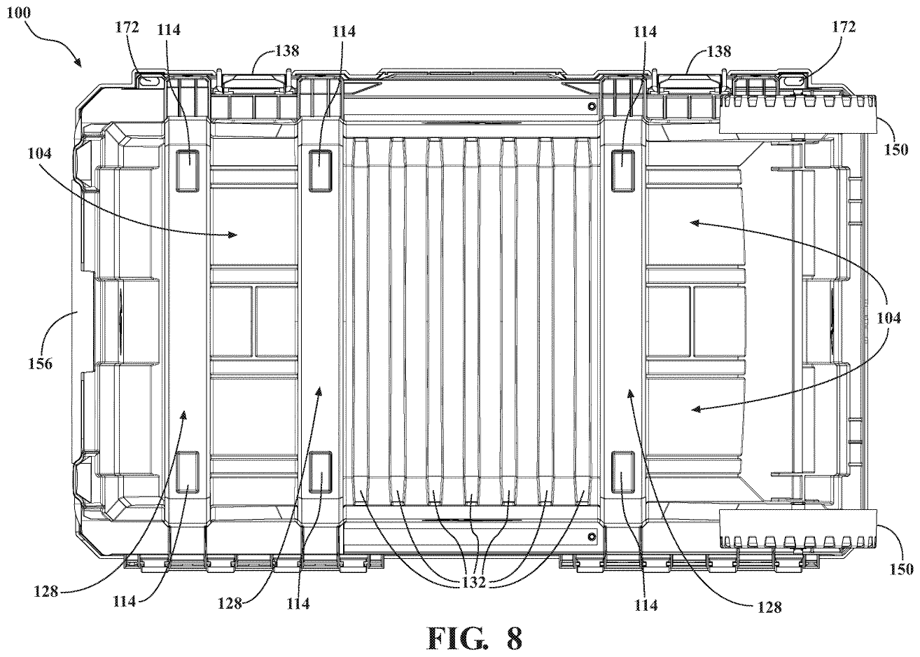

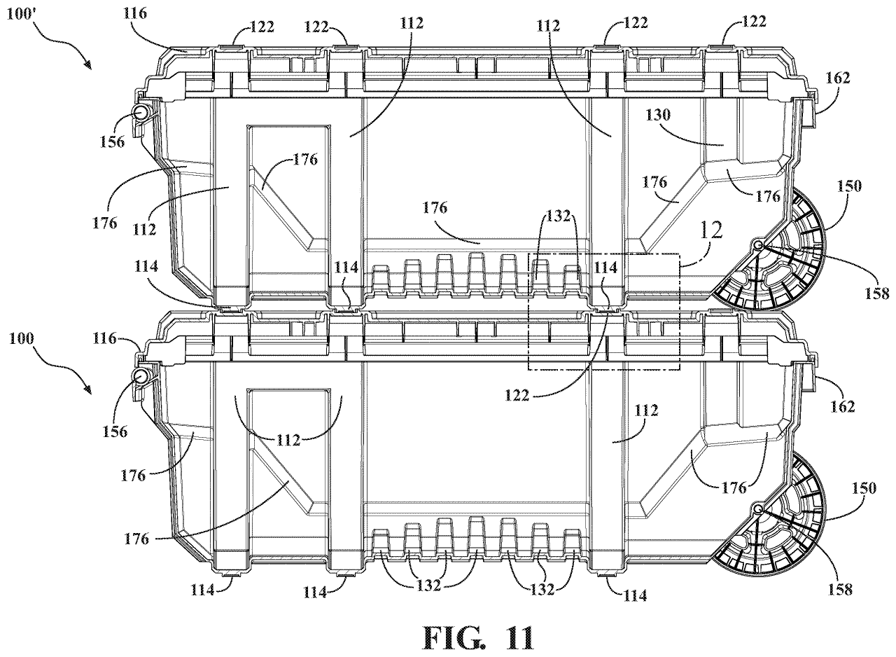

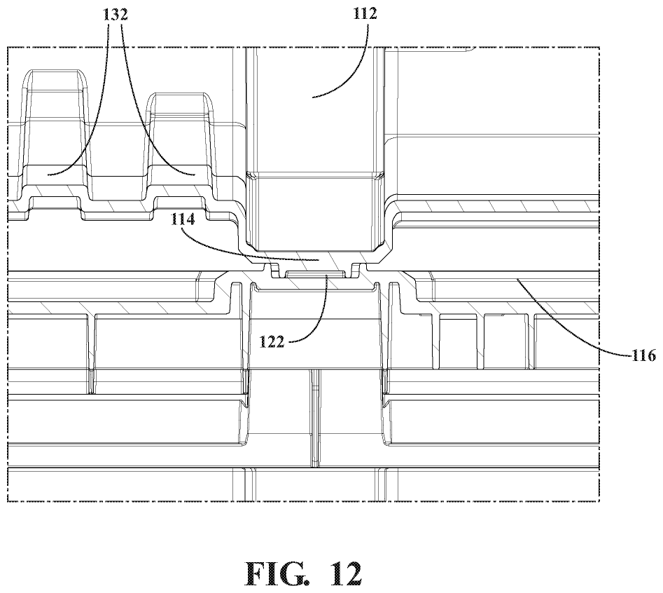

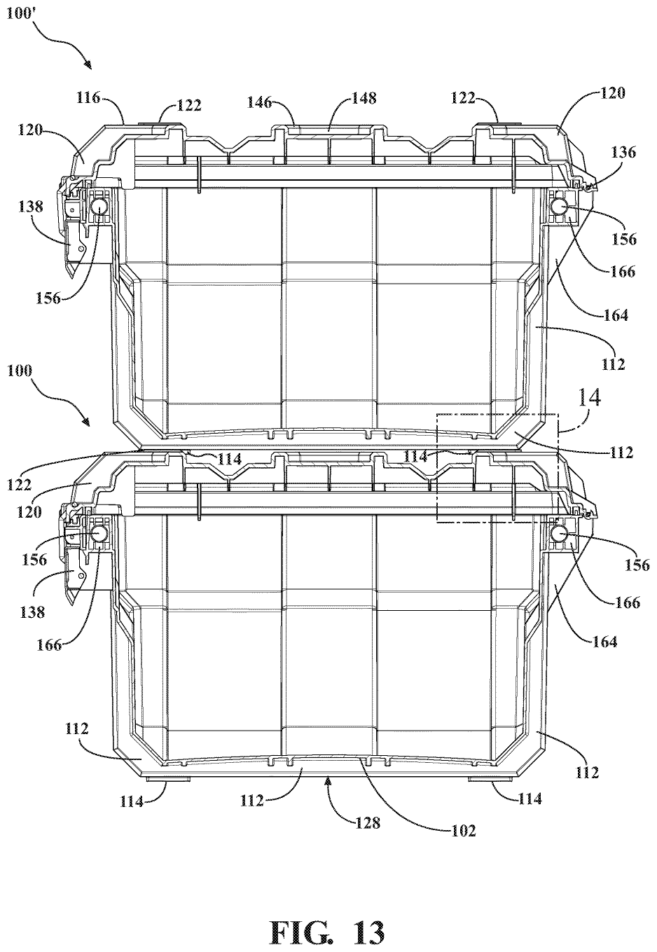

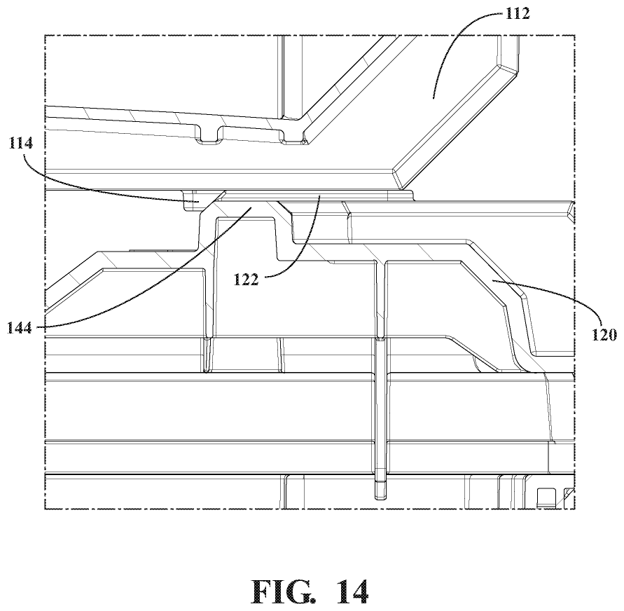

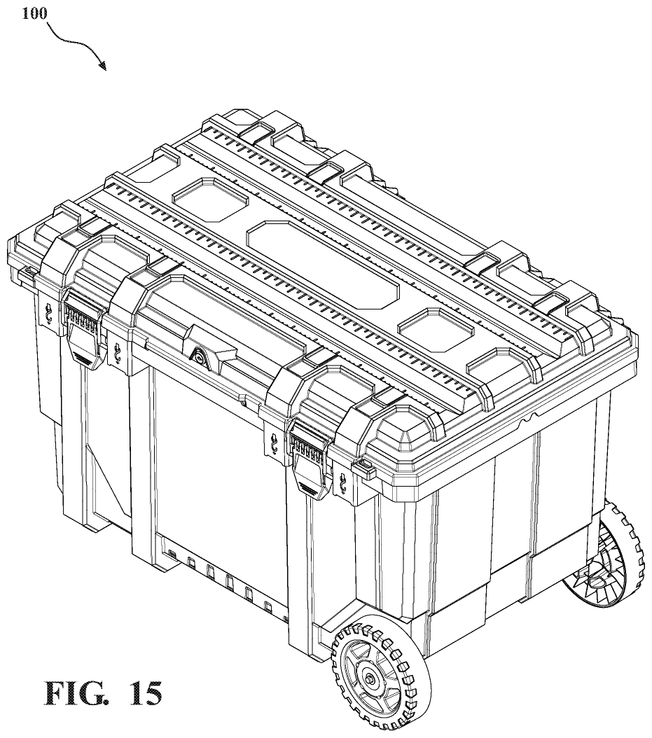

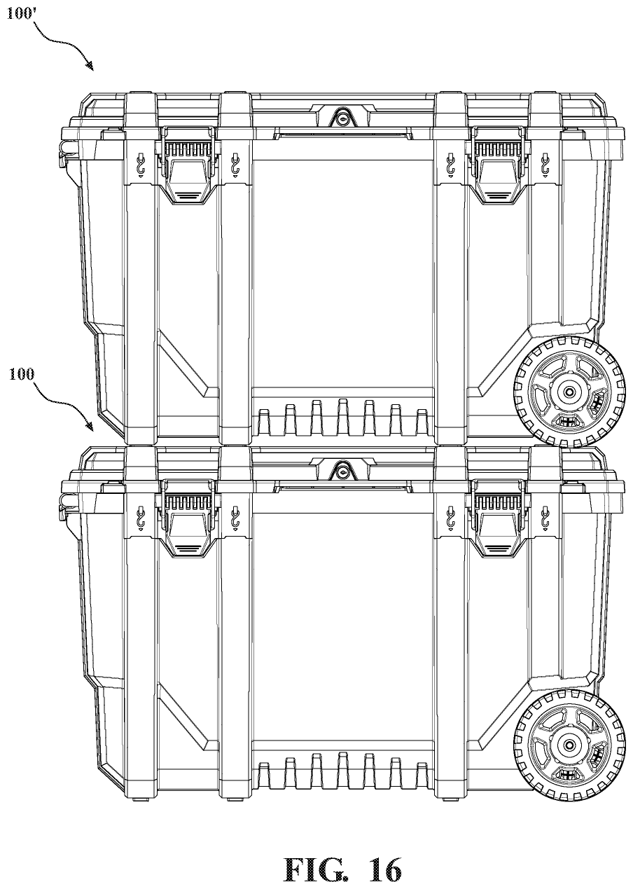

With reference to FIGS. 1-16, a toolbox is provided, aspects of which are described herein. The toolbox 100 can include a base 102 having a bottom surface 104.

Sidewalls 106 can extend from the base 102, the sidewalls 106 including a first sidewall 108 opposite a second sidewall 110. First ribs 112 can extend across the base 102 onto the first sidewall 108 and onto the second sidewall 110. Feet 114 can be disposed on the first ribs 112 and can extend from the bottom of the first ribs 112. The toolbox 100 can also include a lid 116 coupled to the sidewalls 106. The lid 116 can include a top surface 118 including second ribs 120, the second ribs 120 can be positioned to align with the first ribs 112. Recesses 122 can be disposed on the second ribs 120. Each recess 122 can be positioned to receive a corresponding foot 114 of another toolbox 100′ when stacked thereon. The toolbox 100 can be both rollable and stackable, providing flexibility in storage and transport.

In certain embodiments, the toolbox 100 can be formed from a polymer, including polypropylene, polyethylene, high-density polyethylene, and other polyolefins. The polymer can provide impact resistance, allowing the toolbox 100 to withstand drops and impacts during transport and use. The polymer material can also provide UV resistance, allowing the toolbox 100 to be used in outdoor environments without degradation. The polymer can be selected to provide a balance of strength, durability, and weight that can be suitable for the intended use of the toolbox 100.

The base 102 can form the foundation of the toolbox 100 and can provide structural support for the contents stored therein. The base 102 can have the bottom surface 104 that can face downwardly when the toolbox 100 is positioned on a flat surface, such as a floor, a workbench, a garage surface, a job site surface, or another toolbox 100. The base 102 and the lid 116 can support the weight of another toolbox 100 and its contents stacked thereon.

In certain embodiments, the bottom surface 104 of the base 102 can be the lowermost surface of the base 102. The bottom surface 104 can be generally planar and can face downwardly when the toolbox 100 can be in an upright position. The bottom surface 104 can include various structural features, including the first ribs 112 and the feet 114, that can extend downwardly therefrom. The bottom surface 104 can provide a stable foundation for the toolbox 100 when positioned on a flat surface.

In certain embodiments, the base 102 can be rectangular in shape, having a length along a longitudinal axis and a width along a lateral axis. The rectangular shape of the base 102 can provide a practical and efficient storage arrangement for tools and equipment. The rectangular shape can also facilitate stacking of multiple toolboxes 100 in a stable and organized manner. The dimensions of the base 102 can vary depending on the intended use and storage requirements of the toolbox 100. It should be understood that the base 102 can be other shapes, such as square, trapezoidal, or other polygonal shapes, depending on the intended use and storage requirements of the toolbox 100.

The sidewalls 106 can extend upwardly from the base 102 and can define an interior storage space of the toolbox 100. The sidewalls 106 can include the first sidewall 108 and the second sidewall 110 that can be positioned opposite one another. The sidewalls 106 can also include a third sidewall 124 and a fourth sidewall 126 that can couple the first sidewall 108 and the second sidewall 110. The sidewalls 106 can be formed integrally with the base 102 as a unitary piece.

The first sidewall 108 and the second sidewall 110 can be positioned on opposite sides of the base 102 along the longitudinal axis of the toolbox 100. The first sidewall 108 and the second sidewall 110 can each have a height that can define a depth of the interior storage space of the toolbox 100. The first sidewall 108 and the second sidewall 110 can include structural features that can enhance the rigidity and strength of the toolbox 100. The first sidewall 108 and the second sidewall 110 can support the first ribs 112 that can extend thereacross.

The third sidewall 124 and the fourth sidewall 126 can extend between the first sidewall 108 and the second sidewall 110 and can complete the perimeter of the toolbox 100. The third sidewall 124 and the fourth sidewall 126 can each have a height that can be similar to the height of the first sidewall 108 and the second sidewall 110. The third sidewall 124 and the fourth sidewall 126 can include third ribs 174 that can enhance the rigidity and strength of the toolbox 100. The third sidewall 124 and the fourth sidewall 126 can support the lid 116 that can be coupled thereto.

In certain embodiments, each sidewall of the sidewalls 106, including the first sidewall 108, the second sidewall 110, the third sidewall 124, and the fourth sidewall 126, can be shaped such that a first portion and a second portion of each sidewall can be non-coplanar with one another. A transition wall 176 can be provided between the non-coplanar portions. This non-coplanar relationship and the transition wall 176 between the first portion and the second portion of each sidewall can provide additional structural rigidity and strength to the sidewalls 106. The non-coplanar portions can create a stepped profile along each sidewall that can resist deformation and flexing under load. This stepped profile can enhance the overall structural integrity of the toolbox 100 and can contribute to the load-bearing capacity of the toolbox 100 when another toolbox 100 can be stacked thereon.

In certain embodiments, the first ribs 112 can extend across the base 102 and onto the first sidewall 108 and the second sidewall 110. The first ribs 112 can provide structural support and rigidity to the base 102 and the sidewalls 106. Each first rib 112 of the first ribs 112 can start at the first sidewall 108, continue across the bottom surface 104 of the base 102, and extend onto the second sidewall 110. The first ribs 112 can be spaced apart along the longitudinal axis of the toolbox 100.

The first ribs 112 can include three first ribs 112 in certain embodiments. The spacing between adjacent first ribs 112 can be variable, with a distance between a first rib 112 and a second first rib 112 being less than a distance between the second first rib 112 and a third first rib 112. This variable spacing can provide structural advantages and can accommodate an arcuate profile of a portion of the bottom surface 104. The three first ribs 112 can support the feet 114 that can extend downwardly from the bottom surface 104.

Each first rib 112 of the first ribs 112 can have a U-shaped cross-section. The U-shaped cross-section can provide structural rigidity and strength to each first rib 112. The U-shaped cross-section can define a channel that can run along the length of each first rib 112. The U-shaped cross-section can distribute loads evenly across the base 102 and the sidewalls 106.

In certain embodiments, a bottom surface 128 of each first rib 112 of the first ribs 112 can be coplanar with one another. The coplanar bottom surfaces 128 of the first ribs 112 can define a common plane that can facilitate stable contact with a flat surface. The coplanar bottom surfaces 128 can also facilitate stable stacking of the toolbox 100 on top of another toolbox 100. The coplanar bottom surfaces 128 can distribute loads evenly across the first ribs 112.

A pair of second ribs 130 can be disposed on the first sidewall 108 and the second sidewall 110. One second rib 130 of the pair of second ribs 130 can extend along a portion of the first sidewall 108 and another second rib 130 of the pair of second ribs 130 can extend along a portion of the second sidewall 110. The pair of second ribs 130 can provide additional structural support to the first sidewall 108 and the second sidewall 110. The pair of second ribs 130 can enhance the rigidity and strength of the toolbox 100.

Channels 132 can be disposed between a second first rib 112 and a third first rib 112 of the first ribs 112. The channels 132 can be parallel to the first ribs 112. A portion of the bottom surface 104 between the second first rib 112 and the third first rib 112 can be arcuate, and the channels 132 can be disposed along this arcuate portion of the bottom surface 104. The arcuate portion of the bottom surface 104 and the channels 132 can provide additional structural strength and rigidity to the base 102.

Each first rib 112 of the first ribs 112 can be wider than each channel 132 of the channels 132. The difference in width between the first ribs 112 and the channels 132 can facilitate efficient load distribution across the base 102. The width relationship between the first ribs 112 and the channels 132 can also contribute to the overall structural integrity of the toolbox 100.

In certain embodiments, the feet 114 can be disposed on the first ribs 112 and can extend downwardly from a bottom surface 134 of the first ribs 112. The feet 114 can include six feet 114 in certain embodiments, with two feet 114 disposed on each first rib 112 of the first ribs 112. The bottom surface 134 of each foot 114 of the feet 114 can be coplanar with one another. The coplanar bottom surfaces 134 of the feet 114 can facilitate stable contact with a flat surface and can facilitate secure stacking with another toolbox 100.

Each foot 114 of the feet 114 can have a foot width and a foot height. Each recess 122 of the recesses 122 can have a recess width and a recess depth, the recess width sized to receive the foot width and the recess depth being substantially equal to the foot height. The dimensions of the feet 114 and the recesses 122 can provide a snug and secure engagement between stacked toolboxes 100. This dimensional relationship can militate against lateral movement between stacked toolboxes 100 and can provide a stable stacking arrangement.

In certain embodiments, the base 102 and the sidewalls 106 can be formed as a unitary piece. The unitary construction can provide enhanced structural integrity and can simplify the manufacturing process. The base 102 and the sidewalls 106 can be formed by injection molding from a polymer material such as polypropylene or polyethylene. The unitary construction can reduce the number of components and can enhance the overall durability of the toolbox 100.

The toolbox 100 can include a side skirt 162 that can extend from the sidewalls 106 around the perimeter of the toolbox 100 near an open end of the toolbox 100. The side skirt 162 can include a horizontal portion that can extend outwardly from the sidewalls 106 and a downwardly extending portion that can extend downwardly from the horizontal portion. The side skirt 162 can be formed as a unitary piece with the sidewalls 106 and the base 102. The side skirt 162 can engage the lid 116 when the lid 116 can be in a closed position, providing a secure and stable connection between the lid 116 and the toolbox 100.

The side skirt 162 can include reinforcing members 164 that can provide additional structural support to the side skirt 162. The reinforcing members 164 can be gussets that can be disposed on the side skirt 162 and can extend between the horizontal portion and the downwardly extending portion of the side skirt 162. The gussets 164 can resist deformation and flexing of the side skirt 162 under load. The gussets 164 can be spaced apart around the perimeter of the side skirt 162 and can contribute to the overall structural integrity of the toolbox 100.

The lid 116 can be coupled to the sidewalls 106 and can enclose the interior storage space of the toolbox 100. The lid 116 can have a stepped profile, with a first portion and a second portion of the lid 116 being non-coplanar with one another, providing additional structural rigidity and strength to the lid 116. The lid 116 can be hingedly coupled to one sidewall 106 of the sidewalls 106, such as the third sidewall 124 or the fourth sidewall 126, by a pair of hinges 136. A latch 138 can retain the lid 116 in a closed position, securing the contents of the toolbox 100 during transport and storage. The lid 116 and the side skirt 162 can each include apertures 172 that can be aligned with one another when the lid 116 can be in a closed position, the apertures 172 positioned near the front of the toolbox 100 near the latch 138. The apertures 172 can accommodate a variety of locking or securing devices, such as a padlock, a cable lock, or a cable tie, providing flexibility in how the toolbox 100 can be secured.

The lid 116 can include the top surface 118 that can face upwardly when the lid 116 can be in a closed position. The top surface 118 can include the second ribs 120 that can be positioned to align with the first ribs 112. The alignment of the second ribs 120 with the first ribs 112 can facilitate efficient load transfer between stacked toolboxes 100. A top surface 140 of each rib 120 of the second ribs 120 can be coplanar with one another, with the top surfaces 140 of the second ribs 120 defining a topmost surface of the toolbox 100. The recesses 122 can be disposed on the second ribs 120 and can receive corresponding feet 114 of another toolbox 100 when stacked thereon. The recesses 122 can include eight recesses 122 in certain embodiments, with six of the eight recesses 122 corresponding in position to the feet 114. The additional two recesses 122 of the eight recesses 122 can be positioned to accommodate a second toolbox 100 that can be rotated one hundred eighty degrees and stacked thereon. Each recess 122 of the recesses 122 can have a shape that can cooperate to receive a shape of a corresponding foot 114.

In certain embodiments, a first longitudinal rib 142 and a second longitudinal rib 144 can be disposed on the top surface 118 of the lid 116. The first longitudinal rib 142 can be positioned near a front of the lid 116 and can connect a first set of the second ribs 120. The second longitudinal rib 144 can be positioned near a rear of the lid 116 and can connect a second set of the second ribs 120. The first longitudinal rib 142 and the second longitudinal rib 144 can each have a U-shaped cross-section.

A central longitudinal rib 146 can be disposed on the top surface 118 of the lid 116 and can extend along a longitudinal axis of the lid 116. The central longitudinal rib 146 can provide additional structural support to the lid 116 and can enhance the load-bearing capacity of the top surface 118. The central longitudinal rib 146 can include second recesses 148 that can receive or support various objects. The central longitudinal rib 146 can be positioned between the first longitudinal rib 142 and the second longitudinal rib 144 along the lateral axis of the lid 116.

In certain embodiments, wheels 150 can be rotatably coupled to the toolbox 100 and can facilitate transport of the toolbox 100 from one location to another. The wheels 150 can include two wheels 150 that can be positioned at a second longitudinal end 154 of the base 102. A handle 156 can be disposed at a first longitudinal end 152 of the toolbox 100, opposite the second longitudinal end 154, allowing a user to tilt and roll the toolbox 100. The two wheels 150 can be coupled to an axle 158 that can extend between the two wheels 150 and can be coupled to the base 102.

The handle 156 can be a retractable handle that can extend and retract along the first longitudinal end 152 of the toolbox 100. The handle 156 can include a gripping portion that can be grasped by a user to tilt and roll the toolbox 100 on the wheels 150. The handle 156 can be retracted to a stored position when not in use, reducing the overall length of the toolbox 100 along the longitudinal axis. The handle 156 can be extended to an operative position when the user wishes to roll the toolbox 100 from one location to another.

The handle 156 can be received within the side skirt 162 at the first longitudinal end 152 of the toolbox 100 when the handle 156 can be in a retracted or stowed position. The side skirt 162 can include an opening 166 that can receive the handle 156 when the handle 156 can be in the retracted or stowed position. When received within the side skirt 162, the handle 156 can protrude slightly from the side skirt 162, allowing a user to grasp and extend the handle 156 when needed. The receipt of the handle 156 within the side skirt 162 can reduce the overall length of the toolbox 100 along the longitudinal axis, facilitating more compact storage and stacking of the toolbox 100. The handle 156 can include a detent 168 that can militate against the handle 156 being pulled out of the side skirt 162 beyond a predetermined extended position. The detent 168 can engage a corresponding feature (not shown) of the side skirt 162 or the toolbox 100 to retain the handle 156 within a desired range of motion.

The bottom surface 128 of each first rib 112 of the first ribs 112 and a bottom surface 160 of each wheel 150 of the wheels 150 can define a common plane when the toolbox 100 can be positioned on a flat surface. This coplanar relationship can ensure that the toolbox 100 can rest stably on a flat surface when in an upright position. The coplanar relationship can also ensure that the wheels 150 can engage a flat surface when the toolbox 100 can be tilted for rolling. This arrangement can facilitate smooth and stable rolling of the toolbox 100 during transport.

In certain embodiments, the toolbox 100 can be provided in a variety of alternative configurations to suit different storage and transport requirements. The number of wheels 150 can vary, with some embodiments including more than two wheels 150 to provide additional stability during transport. The number and configuration of the first ribs 112 and the second ribs 120 can also vary, with some embodiments including more or fewer ribs to provide different levels of structural support. The toolbox 100 can also be provided in different sizes and shapes to accommodate different types and quantities of tools and equipment.

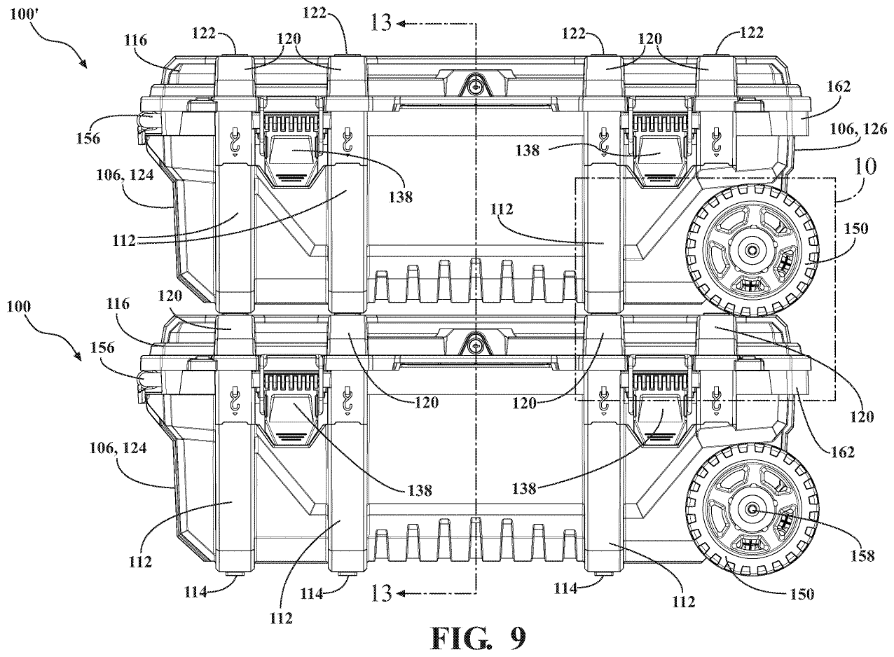

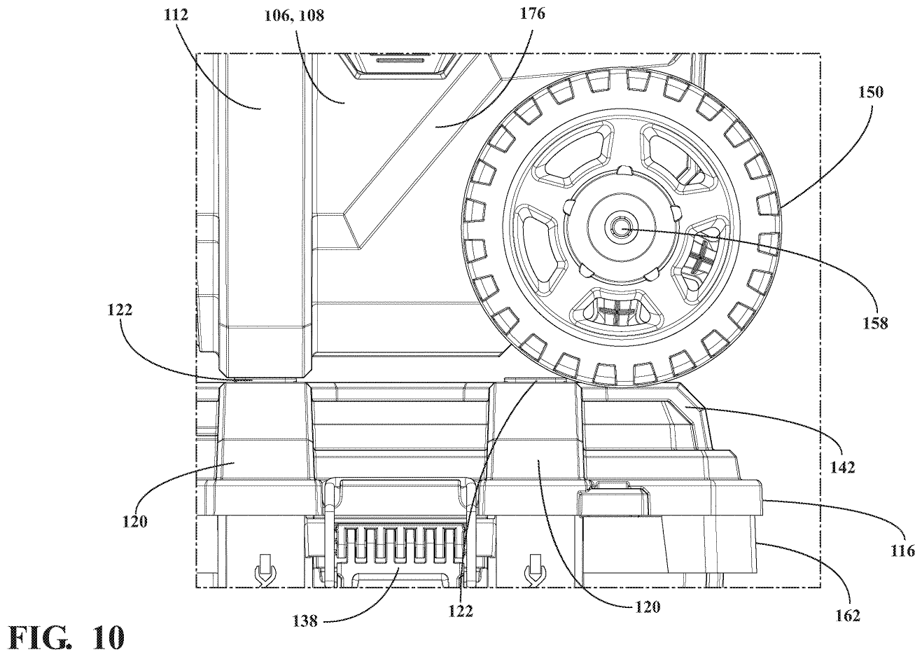

With reference to FIGS. 9-14 and 16, in certain embodiments, the toolbox 100 can be stacked with another toolbox 100 by positioning the second toolbox 100 on top of the first toolbox 100 such that the feet 114 of the second toolbox 100 can be received in the recesses 122 of the first toolbox 100. The engagement between the feet 114 and the recesses 122 can militate against lateral movement of the second toolbox 100 relative to the first toolbox 100. The alignment of the second ribs 120 of the lid 116 with the first ribs 112 of the base 102 can facilitate efficient load transfer between the stacked toolboxes 100. The stacking arrangement can allow multiple toolboxes 100 to be stored vertically, maximizing the use of available storage space.

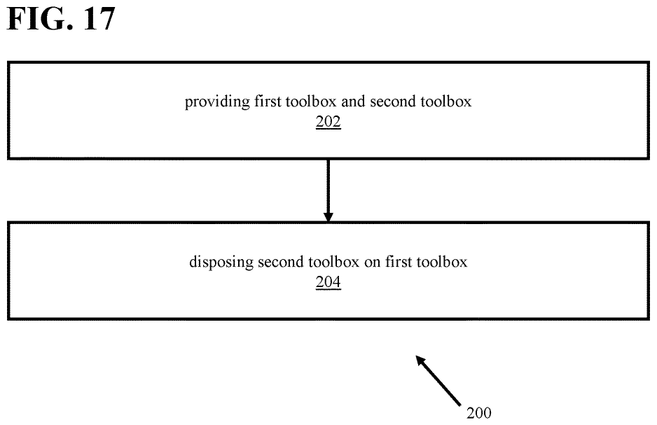

With reference to FIG. 17, a method 200 of stacking a first toolbox 100 and a second toolbox 100′ thereon is provided and described herein. A method 200 of stacking a first toolbox 100 and a second toolbox 100′ thereon can include providing the first toolbox 100 and the second toolbox 100′. Each toolbox 100, 100′ can be the toolbox 100 as described herein. The first toolbox 100 can be positioned on a flat surface with the lid 116 in a closed position. The second toolbox 100′ can be positioned above the first toolbox 100 in preparation for stacking.

The method 200 can include disposing the second toolbox 100′ on the first toolbox 100 such that the feet 114 of the second toolbox 100′ can be received in the recesses 122 of the first toolbox 100. The feet 114 of the second toolbox 100′ can be aligned with the recesses 122 of the first toolbox 100 prior to lowering the second toolbox 100′ onto the first toolbox 100. The engagement between the feet 114 and the recesses 122 can militate against lateral movement of the second toolbox 100′ relative to the first toolbox 100. The first toolbox 100 and the second toolbox 100′ can thereby be placed in a stacked configuration.

The second toolbox 100′ can be placed on the first toolbox 100 in one of two orientations, rotated one hundred eighty degrees relative to one another, and still achieve secure engagement between the feet 114 and the recesses 122. The alignment of the second ribs 120 of the lid 116 of the first toolbox 100 with the first ribs 112 of the base 102 of the second toolbox 100′ can facilitate efficient load transfer between the stacked toolboxes 100, 100′. The stacked configuration can allow multiple toolboxes 100, 100′ to be stored vertically, maximizing the use of available storage space. The wheels 150 of the first toolbox 100 can remain accessible in the stacked configuration, allowing the stacked toolboxes 100, 100′ to be rolled from one location to another.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure.

In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A toolbox, comprising:
a base having a bottom surface;
a plurality of sidewalls extending from the base, the plurality of sidewalls including a first sidewall opposite a second sidewall;
a plurality of first ribs extending across the base onto the first sidewall and onto the second sidewall;
a plurality of feet disposed on the plurality of first ribs and extending from the bottom surface; and
a lid configured to be coupled to the plurality of sidewalls, the lid including a top surface including a plurality of second ribs, the plurality of second ribs positioned to align with the plurality of first ribs, and a plurality of recesses disposed on the plurality of second ribs, each recess positioned and configured to receive a corresponding foot of another toolbox when stacked thereon.

2. The toolbox of claim 1, wherein the plurality of first ribs includes three first ribs.

3. The toolbox of claim 2, wherein a distance between a first rib and a second first rib is less than a distance between the second first rib and a third first rib.

4. The toolbox of claim 1, further comprising a pair of second ribs, wherein one second rib extends along a portion of the first sidewall and another second rib extends along a portion of the second sidewall.

5. The toolbox of claim 1, further comprising a plurality of channels parallel to the plurality of first ribs, the plurality of channels disposed between a second first rib and a third rib of the plurality of first ribs.

6. The toolbox of claim 5, wherein a portion of the bottom surface between the second first rib and the third first rib is arcuate.

7. The toolbox of claim 6, wherein each rib of the plurality of first ribs is wider than each channel of the plurality of channels.

8. The toolbox of claim 1, wherein a bottom surface of each first rib of the plurality of first ribs is coplanar with one another.

9. The toolbox of claim 1, wherein a bottom surface of each foot of the plurality of feet is coplanar with one another.

10. The toolbox of claim 1, wherein each foot of the plurality of feet has a foot width and a foot height, and each recess of the plurality of recesses has a recess width and a recess depth, the recess width configured to receive the foot width and the recess depth being equal to the foot height.

11. The toolbox of claim 10, wherein each recess has a shape that cooperates to receive a shape of a corresponding foot.

12. The toolbox of claim 1, further comprising a latch configured to retain the lid in a closed position.

13. The toolbox of claim 1, wherein a top surface of each rib of the plurality of second ribs is coplanar with one another, the top surfaces of the plurality of second ribs defining a topmost surface of the toolbox.

14. The toolbox of claim 1, further comprising a first longitudinal rib and a second longitudinal rib disposed on the top surface of the lid, the first longitudinal rib positioned near a front of the lid and connecting a first set of the plurality of second ribs, and the second longitudinal rib positioned near a rear of the lid and connecting a second set of the plurality of second ribs.

15. The toolbox of claim 1, further comprising a central longitudinal rib disposed on the top surface of the lid and extending along a longitudinal axis of the lid.

16. The toolbox of claim 1, further comprising a handle disposed at a first longitudinal end of the toolbox.

17. The toolbox of claim 16, further comprising a plurality of wheels disposed at a second longitudinal end of the base, the second longitudinal end opposite the first longitudinal end.

18. A toolbox, comprising:
a base having a bottom surface;
a plurality of sidewalls extending from the base, the plurality of sidewalls including a first sidewall opposite a second sidewall;
a plurality of first ribs extending across the base onto the first sidewall and onto the second sidewall;
a plurality of feet disposed on the plurality of first ribs and extending from the bottom surface;
a lid configured to be coupled to the plurality of sidewalls, the lid including a top surface including a plurality of second ribs, the plurality of second ribs positioned to align with the plurality of first ribs, and a plurality of recesses disposed on the plurality of second ribs, each recess positioned and configured to receive a corresponding foot of another toolbox when stacked thereon;
a plurality of wheels rotatably coupled to the toolbox; and
a handle disposed at a first longitudinal end of the toolbox,
wherein:
the base is rectangular,
the plurality of sidewalls further includes a third sidewall and a fourth sidewall,
the plurality of first ribs includes three first ribs,
a distance between a first rib and a second first rib is less than a distance between the second first rib and a third first rib,
each first rib of the plurality of first ribs has a U-shaped cross-section,
a bottom surface of each first rib of the plurality of first ribs is coplanar with one another,
the plurality of feet includes six feet,
each first rib of the plurality of first ribs has two feet disposed thereon,
each foot of the plurality of feet has a foot width and a foot height, and each recess of the plurality of recesses has a recess width and a recess depth, the recess width configured to receive the foot width and the recess depth being equal to the foot height,
the plurality of recesses includes eight recesses,
six of the eight recesses correspond in position to the plurality of feet,
each recess has a shape that cooperates to receive a shape of a corresponding foot,
the base and the plurality of sidewalls are formed as a unitary piece,
the base and the plurality of sidewalls are formed by injection molding,
the lid is hingedly coupled to the one sidewall by a pair of hinges,
a top surface of each rib of the plurality of second ribs is coplanar with one another, the top surfaces of the plurality of second ribs defining a topmost surface of the toolbox,
the plurality of wheels includes two wheels,
the two wheels are positioned at a second longitudinal end of the base, the second longitudinal end opposite the first longitudinal end, and
the two wheels are coupled to an axle.

19. A toolbox system, comprising:
a first toolbox and a second toolbox, each toolbox including:
a base having a bottom surface;
a plurality of sidewalls extending from the base, the plurality of sidewalls including a first sidewall opposite a second sidewall;
a plurality of first ribs extending across the base onto the first sidewall and onto the second sidewall;
a plurality of feet disposed on the plurality of first ribs and extending from the bottom surface;
a lid configured to be coupled to the plurality of sidewalls, the lid including a top surface including a plurality of second ribs, the plurality of second ribs positioned to align with the plurality of first ribs, and a plurality of recesses disposed on the plurality of second ribs, each recess positioned and configured to receive a corresponding foot of another toolbox when stacked thereon; and
a plurality of wheels rotatably coupled to the toolbox; and
the second toolbox stacked on top of the first toolbox with the plurality of feet of the second toolbox disposed in the plurality of recesses of the first toolbox.

20. A method of stacking a first toolbox and a second toolbox thereon, comprising:
providing the first toolbox and the second toolbox of claim 19; and
disposing the second toolbox on the first toolbox such that the plurality of feet of the second toolbox is received in the plurality of recesses of the first toolbox, whereby the first toolbox and the second toolbox are in a stacked configuration.
